(19) United States
(12) Patent Application Publication
(10) Pub. No.: US 2026/0219776 A1
(43) Pub. Date: Jul. 30, 2026

(54) METHOD, APPARATUS, DEVICE AND MEDIUM FOR EFFECT CREATION

(71) Applicant: Beijing Zitiao Network Technology Co., Ltd., Beijing (CN)

(72) Inventors: Ning WEI, Beijing (CN); Jiaxin MA, Beijing (CN); Wei PENG, Beijing (CN)

(21) Appl. No.: 19/142,144

(22) PCT Filed: Dec. 8, 2023
(86) PCT No.: PCT/CN2023/137623

§ 371 Date: Jun. 20, 2025

(30) Foreign Application Priority Data
Dec. 22, 2022 (CN) 202211657815.8

(51) Int. Cl. G06F 3/04845; G06F 3/04842

(52) U.S. Cl. CPC G06F 3/04845; G06F 3/04842

(57) ABSTRACT

According to embodiments of the disclosure, a method, apparatus, device, and storage medium for effect creation are provided. The method includes: in response to a request from a first user, creating a first effect; presenting the first effect in a user interface; and presenting, in the user interface, at least a second effect with the first effect, the second effect being created by a second user having a social association with the first user. Therefore, user interactivity and interestingness under an effect function may be enhanced. User creation enthusiasm is improved, and creation effects may be more diversified.

This application claims the benefit of Chinese Patent Application No. 202211657815.8, filed on Dec. 22, 2022, entitled ‘METHOD, APPARATUS, DEVICE AND MEDIUM FOR EFFECT CREATION,’the entire content of which is incorporated herein by reference.

### FIELD

Example embodiments of the present disclosure generally relate to the field of computers, and in particular, to a method, apparatus, device, and computer-readable storage medium for effect creation.

### BACKGROUND

More and more applications are being designed to provide various services to users today. For example, a user may view, comment on, and repost various types of contents in an application, including multimedia contents such as videos, images, image sets, sounds, and so on. In addition, a content sharing application allows users to capture and share contents, such as photos, videos, or motion graphics. When capturing a content, the application provides various effects to enrich the content creation of the user.

### SUMMARY

In a first aspect of the present disclosure, a method for effect creation is provided. The method includes: in response to a request from a first user, creating a first effect; presenting the first effect in a user interface; and presenting, in the user interface, at least a second effect with the first effect, the second effect being created by a second user having a social association with the first user.

In a second aspect of the present disclosure, an apparatus for effect creation is provided. The apparatus includes: an effect creating module configured to, in response to a request from a first user, create a first effect; a first effect presenting module configured to present the first effect in a user interface; and a second effect presenting module configured to present, in the user interface, at least a second effect with the first effect, the second effect being created by a second user having a social association with the first user.

In a third aspect of the present disclosure, an electronic device is provided. The device includes: at least one processing unit; and at least one memory coupled to the at least one processing unit and storing instructions for execution by the at least one processing unit, the instructions, when executed by the at least one processing unit, causing the device to perform the method of the first aspect.

In a fourth aspect of the present disclosure, a computer readable storage medium having a computer program stored thereon is provided, the computer program, when executed by a processor, implementing the method of the first aspect.

It should be understood that the content described in the content part of the present disclosure is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure may be implemented;

FIG. 2 illustrates a flowchart of a process for effect creation according to some embodiments of the present disclosure;

FIGS. 3A to 3D are schematic diagrams of a user interface for effect presentation according to some embodiments of the present disclosure;

FIGS. 4A to 4C illustrate schematic diagrams of a user interface for effect customization according to some embodiments of the present disclosure;

FIG. 4D illustrates a schematic diagram of an example for creating a user customized effect according to some embodiments of the present disclosure;

FIG. 5 illustrates a block diagram of an apparatus for effect creation according to some embodiments of the present disclosure; and

FIG. 6 illustrates an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth herein. Rather, these embodiments are provided for a more thorough and complete understanding of the present disclosure. It should be understood that the drawings and embodiments of the present disclosure are for exemplary purposes only and are not intended to limit the scope of the present disclosure.

In the description of the embodiments of the present disclosure, the terms ‘including’, and the like should be understood to include ‘including but not limited to’. The term ‘based on’ should be understood as ‘based at least in part on’. The terms ‘one embodiment’ or ‘the embodiment’ should be understood as ‘at least one embodiment’. The term ‘some embodiments’ should be understood as ‘at least some embodiments’. Other explicit and implicit definitions may also be included below.

It may be understood that the data involved in the technical solution (including but not limited to the data itself, the obtaining or use of the data) should follow the requirements of the corresponding laws and regulations and related regulations.

It may be understood that, before the technical solutions disclosed in the embodiments of the present disclosure are used, the types of personal information related to the present disclosure, the usage scope, the usage scenario and the like should be notified to the user in an appropriate manner according to the relevant laws and regulations, and the creation of the user is obtained.

For example, in response to receiving an active request from a user, prompt information is sent to the user to explicitly prompt the user that the requested operation will need to obtain and use personal information of the user, so that the user may autonomously select whether to provide personal information to software or hardware executing the operation of the technical solution of the present disclosure according to the prompt information.

As an optional but non-limiting implementation, in response to receiving an active request of the user, a manner of sending prompt information to the user may be, for example, a pop-up window, and prompt information may be presented in a text manner in the pop-up window. In addition, the pop-up window may further carry a selection control for the user to select ‘agree’ or ‘disagree’ to provide personal information to the electronic device.

It may be understood that the foregoing notification and obtaining a user creation process are merely illustrative, and do not constitute a limitation on implementations of the present disclosure, and other manners of meeting related laws and regulations may also be applied to implementations of the present disclosure.

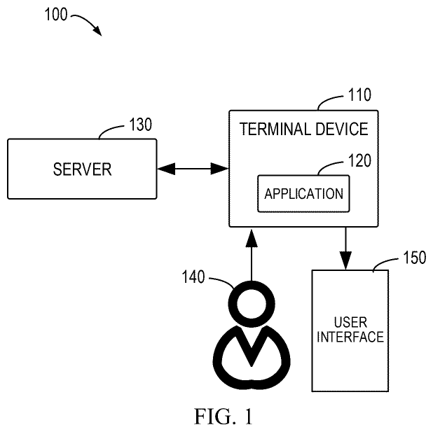

FIG. 1 illustrates a schematic diagram of an example environment 100 in which embodiments of the present disclosure may be implemented. In this example environment 100, an application 120 is installed in a terminal device 110. A user 140 may interact with the application 120 via the terminal device 110 and/or an attachment device of the terminal device 110. The application 120 may be a content sharing application or a social application capable of providing the user 140 with services related to media contents, including browsing, commenting, reposting, creating (e.g., capturing and/or editing), posting, and the like of content. As used herein, ‘media content’ includes one or more types of contents, such as video, images, animated images, image sets, audio, text, and the like.

In the environment 100 of FIG. 1, the terminal device 110 may present a user interface 150 of the application 120. The user interface 150 may include various interfaces that the application 120 may provide, such as a content presenting interface, a content creating interface, a content posting interface, a message interface, a personal homepage, and so forth. The application 120 may provide a content browsing function to browse various types of contents posted in the application 120. The application 120 may also provide a content creating function, including capturing, uploading, editing, and/or posting a media content.

In some embodiments, the terminal device 110 communicates with the server 130 to enable provisioning of services to the application 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 may also support any type of interface of a user (such as a ‘wearable’ circuit, etc.). The server 130 may be various types of computing systems/servers capable of providing computing power, including, but not limited to, mainframes, edge computing nodes, computing devices in a cloud environment, and the like.

It should be understood that the structures and functions of the various elements in the environment 100 are described for example purposes only and do not imply any limitation to the scope of the present disclosure.

In creating a media content, some applications provide an effect function for the application of a wide variety of effects for the media content. Generally, these effects do not have user interaction attributes. The user may only see the effect of using effects when the content is created. The User may only view the use of effects by a further user only when browsing works posted by the further user.

According to an embodiment of the present disclosure, an improved solution for effect creation is provided. In this solution, after the effect is created, in addition to presenting the effect created by the current user, the effect created by the further user having a social association is also presented. Therefore, the interactivity and interestingness of the user under the effect function may be enhanced. Thus, the user creation enthusiasm is improved, and the creating effect may be more diversified.

Some example embodiments of the present disclosure will be described below with continued reference to the accompanying drawings.

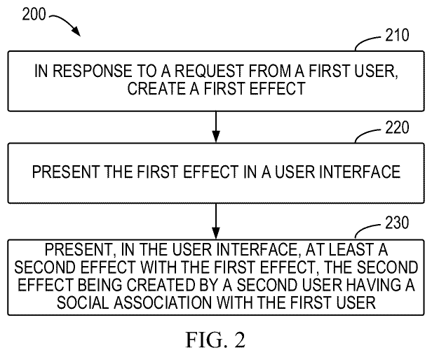

FIG. 2 illustrates a flowchart of a process 200 for effect creation according to some embodiments of the present disclosure. The process 200 may be implemented at a terminal device, such as terminal device 110. For ease of discussion, the process 200 will be described with reference to the environment 100 of FIG. 1.

At block 210, in response to a request from a first user, the terminal device 110 creates a first effect.

In some embodiments, the terminal device 110 is provided with an application 120, which may provide functions such as browsing, commenting, reposting, creating (e.g., capturing and/or editing), posting, and the like of content. Herein, the ‘first user’ may be a registered user of the terminal device 110 or the current user of the application 120, such as the application 120. In creating content, the application 120 may also provide effects function for selection by a user for creating.

In some embodiments, the application 120 may provide one or more props for user selection to create an effect. As used herein, ‘prop’ refers to at least a capability to add a particular visual effect to the media content (e.g., image, video, animated image, image collection, etc.) , such as adding a static or dynamic object in the picture, providing an interactive effect, changing color contrast of the picture, character makeup, and the like. The particular effect that the prop may provide is referred to as an ‘effect’.

In some examples, the effect may include a dynamic effect, such as a dynamic object with an animation effect. The effect may include a static effect, such as an addition of a static object, or a change of a picture. In some embodiments, the effect may include an augmented reality (AR) effect to provide an AR effect. In some embodiments, a user may be allowed to request use of a particular effect or prop. For example, when the user requests to capture the media content, the content to be captured by a certain prop application may be selected. After selecting a prop, a prop may be used to create an effect.

At block 220, the terminal device 110 presents the first effect in a user interface. In addition, at block 230, the terminal device 110 further presents, in the user interface, at least a second effect with the first effect, the second effect being created by a second user. In other words, when the current user (i.e., the first user) creates and presents the effect, the effect created by the further user may be presented in association. In this way, a common presenting of effects created by different users under the same prop may be implemented.

Meanwhile, the ‘second user’ presenting the effect is the user having a social association with the first user. A social association between users may refer to a relationship between a plurality of users that can be associated with each other through an event, behavior, environment, state, etc. In some embodiments, social associations between users may include following between users. For example, the second user presenting the effect at the same time may include a user who is mutually followed with the first user. Such users are sometimes referred to as ‘buddies’ or ‘friends’. Alternatively or in addition, the second user may include a user followed by the first user, but not following the first user. Such users are sometimes referred to as ‘followers’ or ‘following users’. Alternatively or in addition, the second user may include the further user who follows the user, but who is not followed by the user. Such users are sometimes referred to as ‘fans’. In some embodiments, in addition to following between users, the social association between users may include any other way of generating a social relationship, such as where the users are users of the same application, are in the same group, participate in the same activity or topic, are interested in the same activity or topic, and the like.

In some embodiments, a plurality of second effects may be presented with the first effect in the user interface. Such effects may be created by one or more second users. The second effect and the first effect may be presented in the user interface in any relative position, which may be configured in a specific application scenario. The first effect and the second effect may be the same or different.

In some embodiments, the second effect presented may be an effect created and posted by the second user. For example, the second user may create an effect in the captured media content (e.g., video, animated images, images, etc.) and may post such media content. If the effect in the posted media content support being collectively presented in a user interface of the further user, the effect created by the second user may be recorded, for example, by the server 130 in the management application 120 or other devices. For example, data related to the effect may be stored in association with identification information of the second user. In some embodiments, if an access permission of the media content including the effect created by the second user is the public access, the effect may be allowed to be recorded. In some embodiments, if the second user creates effects a plurality of times and posts corresponding media contents, the last effect created by the user may be recorded, or a plurality of different effects may be recorded.

In some embodiments, the terminal device 110 may request at the first user, when the first user requests to create an effect or before the first effect needs to be presented, effect data of the further user having a social association to the server 130 (or a further device recording the effect), and at least present the second effect created by the second user based on the received effect data.

By jointly presenting the effect of the further user having a social association in the effect presenting, the user interaction capability in the effect function may be increased, the creation motivation of the users may be improved, and the visual effect of the content may be enriched.

In some embodiments, for various props that the application 120 may provide, one or more props may be configured to support such associated user effects presentation. In some embodiments, the first effect and the second effect presented may be created using the same target prop. For example, when using a prop to create and present a firework effect, the first user may simultaneously present a firework effect created by the second user using the same prop. In this way, the effect created by the further user is presented in the use process of the prop, simulating the use of the prop and the enthusiasm of the creation, and providing the user interaction capability under the prop. In some embodiments, the first effect and the second effect presented may be created using different props, respectively. In this way, the combination of effects may be richer and more flexible, and diversified effect effects may be provided. In some embodiments, a plurality of props that may be combined to present an effect may be preconfigured. For example, when the first user uses a first prop to create and present the firework effect, it may simultaneously present a starry effect created and presented by the second user using a second prop, and so on.

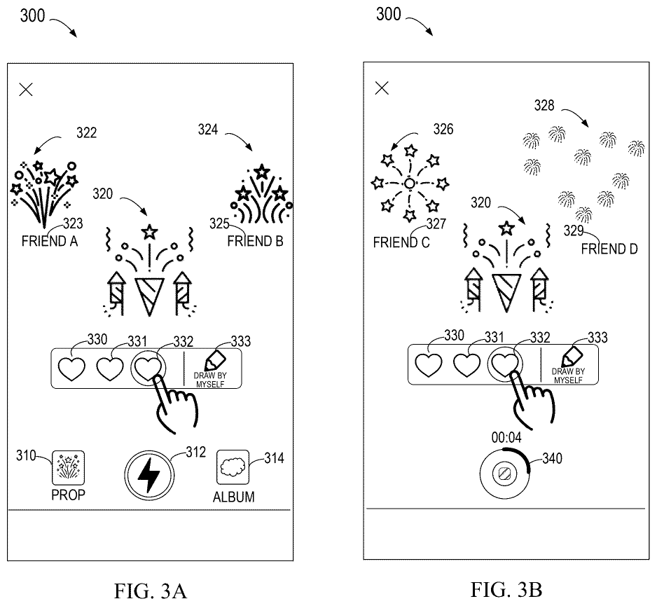

To better understand the example embodiments, an example page of a reference application is described below. FIGS. 3A to 3D illustrate a user interface 300 for presenting effects according to some embodiments of the present disclosure.

It should be understood that the user interfaces in FIG. 3A and other figures described below are merely example interfaces, and various interface designs may actually exist. Respective graphical elements in the interface may have different arrangements and different visual representations, one or more of which may be omitted or replaced, and one or more other elements may also be present. Embodiments of the present disclosure are not limited in this respect.

In the example of FIG. 3A, the user interface 300 is shown as a preview page of an effect. The user interface 300 presents a prop control 310. In response to a selection operation on the prop control 310, a prop selection panel may be presented in which one or more selectable props are presented for content creating. In addition, the user interface 300 further includes a capturing control 312 to control initiation of content capturing. Optionally, the user interface 300 further includes an album control 314. In response to a selection operation on the album control 314, media content, such as images, videos, etc., local to the terminal device 110 may be selected for editing.

In the illustrated example, the first user selects a prop related to a firework effect. The firework effect, such as a firework effect 322, may be created using the prop. The firework effect 322 is presented in the user interface 300. The firework effect 322 may be a static effect or a dynamic effect (e.g., having an animated effect of fireworks blooming). In addition, an effect, such as a firework effect 324, 326, created by the further user with social association using the prop may also be presented in the user interface 300 along with the firework effect 322. The firework effects 324, 326 may, for example, start blooming from the left and right sides of the user interface 300.

By jointly presenting the firework effect created by the further user (for example, a friend), the interaction effect of the friend with the fireworks may be implemented. For a further effect with multi-person interaction characteristics, providing such a presentation manner will also significantly improve interactivity. It should be understood that the firework effect is used as an example in the embodiment of FIG. 3A, and the following embodiments are used as an example for explanation, but the embodiments of the present disclosure are also applicable to other effects.

In some embodiments, information of the second user may also be displayed in association with the second effect. The information of the second user may include the identification information of the second user, for example, a user nickname. Alternatively or in addition, the information of the second user may also include any other relevant information. Embodiments of the present disclosure are not limited in this regard. For example, in FIG. 3A, in addition to the firework effects 324, 326, identification information 325, 327 of a user creating these firework effects is presented in association. In this way, the first user may learn the user creating the corresponding effect.

In some embodiments, the presenting of the second effect may last for a predetermined duration. After the presenting of the second effect reaches the predetermined duration, the terminal device 110 may cease the presenting of the second effect in the user interface. In addition, the information of the second user (if any) may also be ceased. Certainly, the second effect may also be repeatedly presented as needed. In some embodiments, the effect created by the further user having social association with the first user may also be rotated. Specifically, if the presenting of the second effect created by the second user reaches the predetermined duration, the terminal device 110 may cease the presenting of the second effect in the user interface, and at least present a third effect with the first effect in the user interface. The third effect at this time is created by a third user. Similar to the second user, a third user device also has a social association with the first user. In some embodiments, the third effect and the first effect and/or the second effect may be created using the same target prop or different props. In some embodiments, similar to the second effect, a plurality of third effects may be presented together with the first effect in the user interface, which may be created by one or more third users.

As shown in FIG. 3B, in the user interface 300, after the firework effects 322 and 324 are presented for a predetermined duration (the duration may be arbitrarily configured as required), these effects may be ceased, and the additional firework effects 326 and 328 may be presented. Similarly, information that creates the user, such as identification information 323 and 325, may also be presented in association with the firework effects 326 and 328, respectively.

In some embodiments, the terminal device 110 of the first user may obtain effect data of a plurality of further users having social associations with the first user, and group the plurality of users. The effect created by the user in each group is switched to an effect created by a next group of users after a predetermined duration. For example, each two users may be grouped into one group (as shown in the example in FIG. 3A and FIG. 3B), and effects created by each group of users are displayed at predetermined intervals. Certainly, the specific number of users and the predetermined duration of each group may be set based on actual needs and effect types. This is not limited in the present disclosure.

In some embodiments, one or more effect templates may be configured for user selection. For example, selection of an effect template may be supported under a particular prop. Each effect template may specify a generation with a predefined effect pattern. Different predefined effect patterns may, for example, have different visual patterns. For example, for a dynamic effect, the predefined effect may be an effect having a playing by a particular sequence of frames.

In some embodiments, if a certain prop only supports a single effect template, in response to the request from the first user, the terminal device 110 may directly create the first effect with the corresponding effect template.

In some embodiments, if a certain prop supports a plurality of effect templates, the first user may be allowed to select between a plurality of effect templates. In some embodiments, if the prop is selected for effect creation, the terminal device 110 may present a plurality of interface elements respectively corresponding to the plurality of effect templates. In response to a selection of one of the plurality of interface elements, the terminal device 110 may create the first effect with the effect template corresponding to the selected interface element, and correspondingly present the first effect. That is, by selection of an interface element, switching and selection may be made between different effect patterns.

As shown in FIGS. 3A and 3B, interface elements 330, 331, and 332 are presented in the user interface 300, each interface element corresponding to a different effect template. By selecting these interface elements, a corresponding effect template may be selected to create different effects. In the example of FIGS. 3A and 3B, it is assumed that the interface element 332 is selected. A corresponding firework effect 320 is created with the effect template corresponding to the interface element. Note that although three interface elements are illustrated in the figure, any other appropriate number of effect templates may in fact be configured and any other number of interface elements presented. In some embodiments, a single interface element may also be presented for switching between a plurality of different effect templates, thereby creating a corresponding effect.

As previously mentioned, the effect created and posted by the user need to be recorded to facilitate common presenting of effect at the further user associated therewith. In some embodiments, if the user (for example, the second user and/or the third user) create the effect (for example, the second effect and/or the third effect) with the effect template, the identifier of the effect template may be recorded as effect data and stored in association with the identification information of the user. In this way, if the effect created by the second user and/or the third user is to be presented to the first user, the server 130 (or a further device for recording an effect) may send the identifier of the effect template and the identification information of the user to the terminal device 110. The terminal device 110 may create and present a corresponding effect based on the identifier of the effect template.

The first effect created by the current user and the effect created by the further user are presented in the preview page of the effect in FIGS. 3A and 3B. In this way, the user may preview the effect. Additionally or alternatively, the first effect and the effects created by the further user may also be presented in association in other user interfaces.

In some embodiments, the user interface for presenting the first effect and the effect created by the further user may include a recording page of the effect. In a recording page, an effect (and further contents) may be recorded as a work (e.g., image, video, etc.) . In the recording page, in addition to presenting the first effect created by the first user, an effect created by the further user with whom the first user has a social connection may also be presented. The manner of presenting the effect in the recording page of the effect is similar to that discussed above in conjunction with the preview page of the effect. In some embodiments, the effects of the further user presented in the recording page, such as the second effect of the second user and the third effect of the third user, may be simultaneously recorded into the work created by the first user together with the first effect. In other embodiments, the effect of the further user may only be presented without being recorded into the work of the first user. For example, prompt information may be provided in the user interface to indicate whether the effect of the further user will be recorded.

FIG. 3C illustrates an example user interface 302 in the form of a recording page. In some examples, the user interface 302 may be entered by selecting a capture control 312 in the user interface 300. A capture progress indication control 340 is presented in the user interface 302 to indicate that a recording is being made. Similar to the user interface 300, the user-created firework effect 320 may be presented in the user interface 302. The user interface 302 may also present interface elements 330, 331, and 332 such that the user selects to create a different effect pattern for recording. In addition, the firework effects 322 and 324 created by a further user may also be presented in the user interface 302, as well as the identification information 323 and 325 of the users creating these effects.

In some embodiments, the effects of the further user may not be presented in the preview page, but the effects of the further user may be presented in the recording page. In some embodiments, effects of the further user may also be allowed to be presented in both the preview page and the recording page.

Alternatively or in addition, the user interface for presenting the first effect and the effect created by the further user may include a posting page of effects. In the posting page, a recorded work (e.g., image, video, etc.) containing the created effect may be posted. In the posting page, in addition to the first effect created by the first user, the effect created by the further user with a social association with the first user may be presented. The manner of presenting effects on the posting page of an effect is similar to the presenting of effects discussed above in conjunction with the preview page of an effect. Presenting an effect created by the further user on the posting page may encourage the user to post their work even more.

FIG. 3D illustrates an example user interface 304 in the form of a recording page. In some examples, the user interface 304 may be entered by selecting the capture progress indication control 340 in the user interface 302. Direct post control 360 and next control 352 are presented in the user interface 304. By selecting the direct post control 360, the work may be directly posted. By selecting the next control 352, a post editing page may be presented to allow the user to edit posting related information, such as adding text, setting a work access permission, reminding the further user to follow, and the like. Similar to the user interface 300, the user-created firework effect 320 may be presented in the user interface 304. In addition, the firework effects 322 and 324 created by the further user may also be presented in the user interface 304, as well as the identification information 323 and 325 of the users creating these effects.

A user interface presenting effects created by the further user is discussed above. In practical applications, any other suitable user interface may also be configured to allow effects created by the current user to be presented with effects created by the further user.

In some embodiments, the user may be allowed to customize an effect in addition to or as an alternative to providing an effect template with a predefined effect patterns. As shown in FIGS. 3A, 3B, and 3C, an interface element 333 is also presented in the user interface. In response to a selection of the interface element, an effect customization mode may be entered. In the effect customization mode, the user may be supported to input some or all of the trajectory or contour associated with an effect, and create an effect, for example, the first effect, based on the trajectory or contour specified by the user input. The trajectory of the effect may be used to specify a display order or route of the effect, for example, a dynamic effect of the effect may be presented from a start point to an end point of the trajectory. The contour of the effect may be configured to specify an approximate shape of the effect, and an animation effect of the effect may be predetermined. In this way, different from the predefined effect pattern, in the customization mode, the user may flexibly customize the trajectory or contour corresponding to the effect based on needs, thereby creating a rich and diverse effect conforming to the expectation of the user.

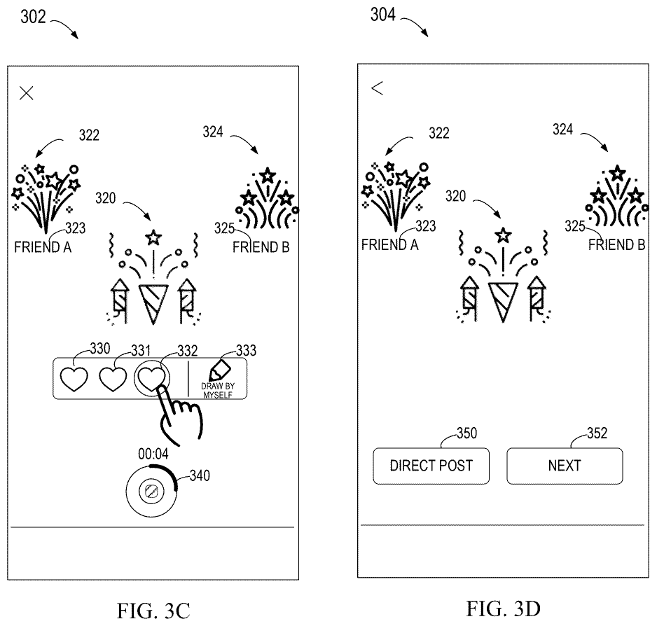

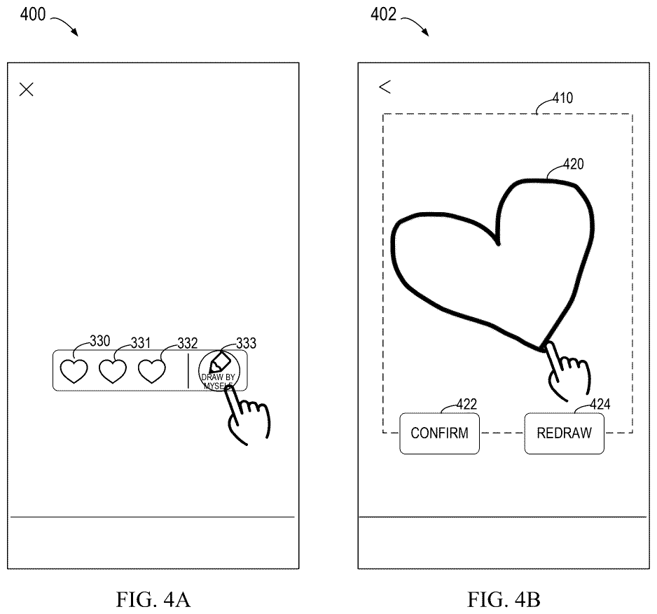

Creation of a customized effect will be discussed below with reference to FIGS. 4A to 4D.

As shown in FIG. 4A, a selection of the interface element 333 is received in a user interface 400. The user interface 400 may be similar to the user interface 300 of FIGS. 3A and 3B, or the user interface 302 of FIG. 3C. The user interface 400 may also present an effect of the user interface 300 or 302 or may not present an effect.

In response to the selection of the interface element 333, the user interface 402 of FIG. 4B is presented. The user may be allowed to freely create in the user interface 402. For example, a region 410 of the user interface 402 may be configured to receive user input. The terminal device 110 may receive a user input from the region 410 specifying at least a part of a trajectory or contour associated with the effect. In some embodiments, the user input may be a touch input, for example, an auxiliary tool input such as a finger or a touch pen.

In the example of FIG. 4B, a trajectory or contour 420 specified by a user input is shown. In some embodiments, the user interface 402 also presents a confirm control 422 for confirming the user input, and a redraw control 424 for redrawing a new trajectory or contour. Upon receiving a user confirmation (e.g., a selection of the confirm control 422), an effect may be created based on the trajectory or contour 420. A created firework effect 440 is presented in a user interface 403 of FIG. 4C with a user-specified heart-shaped contour. In some embodiments, if a user specified trajectory is supported, the firework effect 440 may also be played in a user-inputted order (and/or speed) of the start of the trajectory, etc., such as a gradual blooming of fireworks along a heart-shaped trajectory. In addition, as shown in FIG. 4C, the current user customized firework effect 440 may also be presented in the user interface 403 with other user-created firework effects 322, 324 (similar to the examples of FIGS. 3A and 3C).

In some embodiments, switching may be allowed between an effect customization mode and an effect template selection. For example, if an exit indication of the effect customization mode is received in the user interface 402 of FIG. 4B, it may be returned to present the user interface 400 as in FIG. 4A. In the user interface 400, the user may select the interface elements 330, 331, and 332 corresponding to different effect templates, thereby creating an effect with a predefined pattern.

In some embodiments, automatic completion of a trajectory or contour entered by a user may be supported. Specifically, if the received user input specifies a part of the trajectory or contour, the terminal device 110 may complete the trajectory or contour, and create the first effect based on the completed trajectory or contour. In some embodiments, the trajectory or contour associated with the effect may have a symmetrical shape or a closed shape. In this way, the terminal device 110 may complete the trajectory or contour into a symmetrical shape or a closed shape based on the user input. For example, the user may input only a left half of a heart shape and then automatically complete the right half of the heart shape by the device. For a further shape, the completion may also be performed in a symmetrical or closed principle. In this way, not only may the user input be simplified, but also the beauty of the generated effect may be ensured.

In some embodiments, the effect customization mode may last for a certain predetermined duration. For example, the region 410 shown in FIG. 4B may disappear after a period of time, thereby returning to the user interface 400. In some embodiments, the effect customization mode may continue until an exit indication is received from the user or the user confirms completion of drawing the trajectory or contour. In some embodiments, if no user input for the trajectory or contour is received from the user in the effect customization mode (and the user selects the confirm control) or if the effect customization mode is automatically exited after a certain duration without user input, the first effect created based on a default effect template, as well as a further user-created effect may be presented in the user interface. These specific implementations of the effects customization mode can be chosen based on the actual needs.

In some embodiments, when creating the first effect based on the trajectory or contour, the terminal device 110 may determine a plurality of points on the specified trajectory or contour (or the complementary trajectory or contour) of the user input and arrange the predefined effect element at each determined point. For example, the terminal device 110 may sample, at a predetermined interval, a plurality of points from the trajectory or the contour for arranging the effect element. In some embodiments, if the trajectory or contour is detected by a user touch input on the touch screen, a plurality of touch points may be selected for arranging the effect element by detecting a touch point on the touch screen and selecting a plurality of touch points at a predetermined interval.

An effect element is a unit for composing an overall effect. Each effect element may have an animation effect or may also be static. The effect elements at a plurality of points of the trajectory or contour may constitute a final first effect. In some embodiments, if the created effect is a firework effect, the effect element may be an effect element having a firework effect. In this way, a series of effect elements with firework effect may form a final effect. In other examples, a further effect element may also be defined for composing a further effect element. In some embodiments, for a particular effect, a plurality of effects elements may be configured, which may be arranged randomly or sequentially to a plurality of points sampled from a trajectory or contour. In some embodiments, the effect element to be used may also be determined based on user selection.

In some embodiments, in the effect customization mode, in addition to supporting customization of the trajectory or the contour by the user, customization of the effect pattern corresponding to some or all of the trajectory or contour may also be supported by the user. The effect pattern specified herein may include an effect element (for example, a type, a color, a shape, and the like) of the effect element, a playing effect (for example, a play speed) of the effect element, a degree of sparsity between the effect elements, and the like. For example, a user may specify that a first part of a trajectory or contour is to arrange a first effect element and a second part of the trajectory or contour to arrange a second effect element. The terminal device 110 receives a user input specifying an effect pattern corresponding to at least a part of the trajectory or contour and creates the first effect based on the trajectory or the contour and the effect pattern specified by the second user input. When the effect part corresponding to a certain part of the trajectory or contour is created, the terminal device 110 will generate the effect part based on the effect pattern specified by the user. For example, the terminal device 110 may arrange the first effect element in the first part of the trajectory or contour and the second effect element in the second part of the trajectory or contour.

FIG. 4D illustrates an example of effect element creation for a trajectory or contour. As shown, for the trajectory or contour 420 specified by the user input received in FIG. 4B, a plurality of points 430 may be sampled at a predetermined interval and an effect element 432 having a firework effect is arranged at each point. With such sampling and arrangement, the firework effect 440 as shown in FIG. 4C may be generated.

In some embodiments, if the created effect is an AR effect, when the effect is created, a two-dimensional coordinate position of the point obtained by sampling the trajectory or the contour may be converted into a three-dimensional coordinate position in the three-dimensional space, and the effect element is arranged at the corresponding coordinate position. The conversion of the two-dimensional coordinate position to the three-dimensional coordinate position may be determined based on any suitable conversion rule or conversion algorithm, and the scope of the embodiments of the present disclosure is not limited in this respect.

In some embodiments, as mentioned above, the effect created and posted by the user need to be recorded to facilitate co-presentation of the effects at a further user associated therewith. In some embodiments, if the user (e.g., the second user and/or the third user) creates the customized effect (e.g., the second effect and/or the third effect) in the effect customization mode, effect data indicating a plurality of points on the trajectory or contour may be recorded based on the effect type being a customization type and stored in association with the identification information of the user. In this way, if an effect created by the second and/or third user is to be presented to the first user, the server 130 (or a further device recording the effect) may send to the terminal device 110 effect data indicating a plurality of points on the trajectory or contour and identification information of the user. The terminal device 110 arranges a predefined effect element at each of the points indicated by the effect data so as to be able to present an effect customized by the second user and/or the third user.

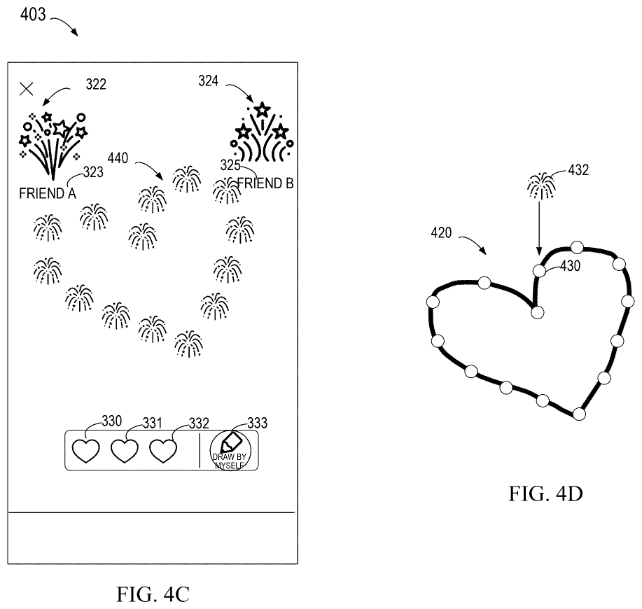

FIG. 5 is a schematic structural block diagram of an apparatus 500 for effect creation according to some embodiments of the present disclosure. The apparatus 500 may be implemented or included in the terminal device 110. The various modules/components in the apparatus 500 may be implemented by hardware, software, firmware, or any combination thereof.

The apparatus 500 includes an effect creating module 510 configured to, in response to a request from a first user, create a first effect.

The apparatus 500 further includes a first effect presenting module 520 configured to present the first effect in a user interface; and a second effect presenting module 530 configured to present, in the user interface, at least a second effect with the first effect, the second effect being created by a second user having a social association with the first user.

In some embodiments, the user interface is at least one of the following: a preview page of the first effect; a recording page of the first effect; or a posting page of the first effect.

In some embodiments, the first effect and the second effect are created with a target prop.

In some embodiments, the effect creating module 510 includes: an interface element presenting module configured to present to the first user a plurality of interface elements respectively corresponding to a plurality of effect templates; and a template-based creating module configured to, in response to a selection of one of the plurality of interface elements, create the first effect with an effect template corresponding to the selected interface element.

In some embodiments, the effect creating module 510 includes: a first input receiving module configured to receive a first user input specifying at least a part of a trajectory or contour associated with an effect; and an input-based creating module configured to create the first effect based on the trajectory or contour.

In some embodiments, the input-based creating module includes: a completing module configured to complete the trajectory or contour based on the at least part of the trajectory or contour specified by the first user input; and a complement-based creating module configured to create the first effect based on the completed trajectory or contour.

In some embodiments, the input-based creating module includes: a second input receiving module configured to receive a second user input specifying an effect pattern corresponding to at least a part of the trajectory or contour; and a pattern-based creating module configured to create the first effect based on the trajectory or contour and the effect pattern specified by the second user input.

In some embodiments, the input-based creating module includes: a point determining module configured to determine a plurality of points on the trajectory or contour specified by the user input; and an element arranging module configured to arrange a predefined effect element at each of the determined point.

In some embodiments, the first effect is a firework effect and the predefined effect element comprises an effect element having the firework effect.

In some embodiments, the apparatus 500 further includes: a user information presenting module configured to present, in association with the second effect, information of the second user.

In some embodiments, the apparatus 500 further includes: a presentation ceasing module configured to, in response to the presenting of the second effect reaching a predetermined duration, cease the presenting of the second effect in the user interface.

In some embodiments, the apparatus 500 further includes: a third effect presenting module configured to, after the presenting of the second effect is ceased, at least a third effect with the first effect in the user interface, the third effect being created by a third user having a social association with the first user.

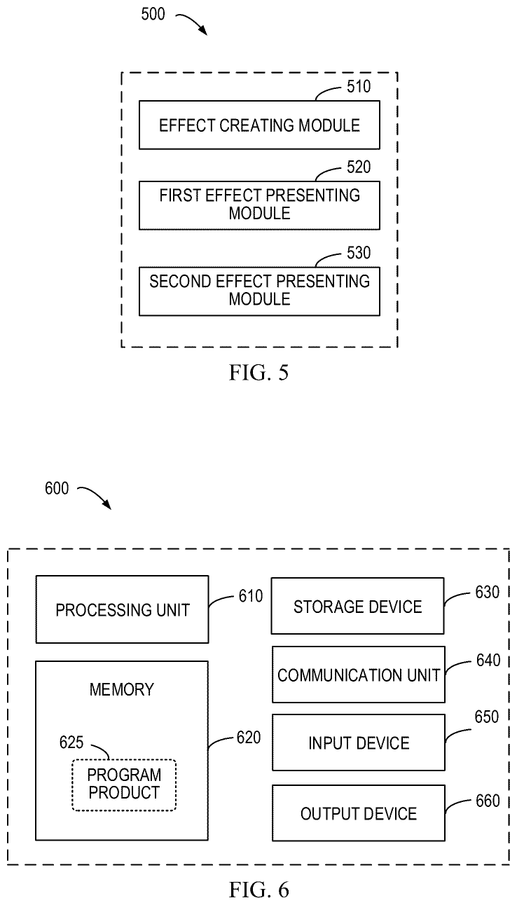

FIG. 6 illustrates a block diagram of an electronic device 600 in which one or more embodiments of the present disclosure may be implemented. It should be understood that the electronic device 600 illustrated in FIG. 6 is merely for example and should not constitute any limitation on the function and scope of the embodiments described herein. The electronic device 600 shown in FIG. 6 may be configured to implement the terminal device 110 in FIG. 1.

As shown in FIG. 6, the electronic device 600 is in a form of a general-purpose electronic device. Components of the electronic device 600 may include, but are not limited to, one or more processors or processing units 610, memory 620, storage device 630, one or more communication units 640, one or more input devices 650, and one or more output devices 660. The processing units 610 may be actual or virtual processors and are capable of performing various processes based on programs stored in the memory 620. In a multiprocessor system, a plurality of processing units perform computer-executable instructions in parallel to increase the parallel processing power of the electronic device 600.

The electronic device 600 typically includes a plurality of computer storage media. Such media may be any obtainable media accessible to the electronic device 600, including, but not limited to, volatile and non-volatile media, removable and non-removable media. The memory 620 may be volatile memory (e.g., registers, cache, random access memory (RAM)), non-volatile memory (e.g., read-only memory (ROM), electrically erasable programmable read-only memory (EEPROM), flash memory), or some combination thereof. The storage device 630 may be a removable or non-removable medium and may include a machine-readable medium, such as a flash drive, a disk, or any other medium that may be capable of being used to store information and/or data (e.g., training data for training) and may be accessible within the electronic device 600.

The electronic device 600 may further include additional removable/non-removable, volatile/non-volatile storage media. Although not shown in FIG. 6, a disk drive for reading from or writing to a removable, non-volatile disk (e.g., a ‘floppy disk’) and an optical disk drive for reading from or writing to a removable, non-volatile optical disk may be provided. In these embodiments, each drive may be connected to a bus (not shown) by one or more data media interfaces. The memory 620 may include a computer program product 625 having one or more program modules that are configured to perform various methods or actions of various embodiments of the present disclosure.

The communication unit 640 implements communication with other electronic devices via a communication medium. Additionally, the functions of the components of the electronic device 600 may be implemented as a single computing cluster or a plurality of computing machines that are capable of communicating over a communication connection. Thus, the electronic device 600 may use logical connections to one or more other servers, networked personal computers (PCs), or another network node to operate in a networked environment.

The input device 650 may be one or more input devices, such as a mouse, a keyboard, a tracking ball, and the like. The output device 660 may be one or more output devices, such as a monitor, a speaker, a printer, and the like. The electronic device 600 may also communicate, as desired, via the communication unit 640, with one or more external devices (not shown), external devices such as storage devices, display devices, etc., with one or more devices that enable a user to interact with the electronic device 600, or with any device that enables the electronic device 600 to communicate with one or more other electronic devices (e.g., a network card, modem, etc.) to communicate. Such communication may be performed via an input/output (I/O) interface (not shown).

According to example implementations of the present disclosure, a computer-readable storage medium having a computer program stored thereon is provided, the program, when performed by a processor, implementing the method described above. According to example implementations of the present disclosure, a computer program product is also provided, the computer program product being tangibly stored on a non-transitory computer-readable medium and including computer-executable instructions, and the computer-executable instructions being performed by a processor to implement the methods described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, function, and operation of possible implementations of systems, methods, and computer program products according to various implementations of the present disclosure. In this regard, each block in the flowchart or block diagram may represent a module, program segment, or part of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the function involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1-15. (canceled)

16. A method for effect creation, comprising:
in response to a request from a first user, creating a first effect;
presenting the first effect in a user interface; and
presenting, in the user interface, at least a second effect with the first effect, the second effect being created by a second user having a social association with the first user.

17. The method of claim 16, wherein the user interface is at least one of the following:
a preview page of the first effect;
a recording page of the first effect; or
a posting page of the first effect.

18. The method of claim 17, wherein the first effect and the second effect are created with a target prop.

19. The method of claim 16, wherein creating the first effect comprises:
presenting to the first user a plurality of interface elements respectively corresponding to a plurality of effect templates; and
in response to a selection of one of the plurality of interface elements, creating the first effect with an effect template corresponding to the selected interface element.

20. The method of claim 16, wherein creating the first effect comprises:
receiving a first user input specifying at least a part of a trajectory or contour associated with an effect; and
creating the first effect based on the trajectory or contour.

21. The method of claim 20, wherein creating the first effect based on the trajectory or contour comprises:
completing the trajectory or contour based on the at least part of the trajectory or contour specified by the first user input; and
creating the first effect based on the completed trajectory or contour.

22. The method of claim 20, wherein creating the first effect based on the trajectory or contour comprises:
receiving a second user input specifying an effect pattern corresponding to at least a part of the trajectory or contour; and
creating the first effect based on the trajectory or contour and the effect pattern specified by the second user input.

23. The method of claim 20, wherein creating the first effect based on the trajectory or contour comprises:
determining a plurality of points on the trajectory or contour specified by the user input; and
arranging a predefined effect element at each of the determined point.

24. The method of claim 23, wherein the first effect is a firework effect and the predefined effect element comprises an effect element having the firework effect.

25. The method of claim 16, further comprising:
presenting, in association with the second effect, information of the second user.

26. The method of claim 16, further comprising:
in response to the presenting of the second effect reaching a predetermined duration, ceasing the presenting of the second effect in the user interface.

27. The method of claim 26, further comprising:
presenting, after the presenting of the second effect is ceased, at least a third effect with the first effect in the user interface, the third effect being created by a third user having a social association with the first user.

28. An electronic device, comprising:
at least one processing unit; and
at least one memory coupled to the at least one processing unit and storing instructions for execution by the at least one processing unit, the instructions, when executed by the at least one processing unit, causing the device to perform acts comprising:
in response to a request from a first user, creating a first effect;
presenting the first effect in a user interface; and
presenting, in the user interface, at least a second effect with the first effect, the second effect being created by a second user having a social association with the first user.

29. The electronic device of claim 28, wherein the user interface is at least one of the following:
a preview page of the first effect;
a recording page of the first effect; or
a posting page of the first effect.

30. The electronic device of claim 29, wherein the first effect and the second effect are created with a target prop.

31. The electronic device of claim 28, wherein creating the first effect comprises:
presenting to the first user a plurality of interface elements respectively corresponding to a plurality of effect templates; and
in response to a selection of one of the plurality of interface elements, creating the first effect with an effect template corresponding to the selected interface element.

32. The electronic device of claim 28, wherein creating the first effect comprises:
receiving a first user input specifying at least a part of a trajectory or contour associated with an effect; and
creating the first effect based on the trajectory or contour.

33. The electronic device of claim 32, wherein creating the first effect based on the trajectory or contour comprises:
completing the trajectory or contour based on the at least part of the trajectory or contour specified by the first user input; and
creating the first effect based on the completed trajectory or contour.

34. The electronic device of claim 32, wherein creating the first effect based on the trajectory or contour comprises:
receiving a second user input specifying an effect pattern corresponding to at least a part of the trajectory or contour; and
creating the first effect based on the trajectory or contour and the effect pattern specified by the second user input.

35. A non-transitory computer readable storage medium having a computer program stored thereon, the computer program, when executed by a processor, implementing acts comprising:
in response to a request from a first user, creating a first effect;
presenting the first effect in a user interface; and
presenting, in the user interface, at least a second effect with the first effect, the second effect being created by a second user having a social association with the first user.
